(19) United States
(12) Patent Application Publication
(10) Pub. No.: US 2007/0170784 A1
(43) Pub. Date: Jul. 26, 2007

(54) Lamp system having power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD, Taipei City (TW)

(21) Appl. No.: 11/594,240

(22) Filed: Nov. 8, 2006

(30) Foreign Application Priority Data
Dec. 15, 2005 (TW) 094220045

(51) Int. Cl. H02J 1/00

(52) U.S. Cl. 307/71

(57) ABSTRACT

The present invention provides a control device to automatically switch on or off a lamp by using a power frequency carrier transmitted in a power line.

### FIELD OF THE INVENTION

The present invention relates to a lamp system; more particularly, relates to controlling the switching of a lamp device by using a first and a second power frequency carrier unit coordinated with a switching device and a control member.

### DESCRIPTION OF THE RELATED ART

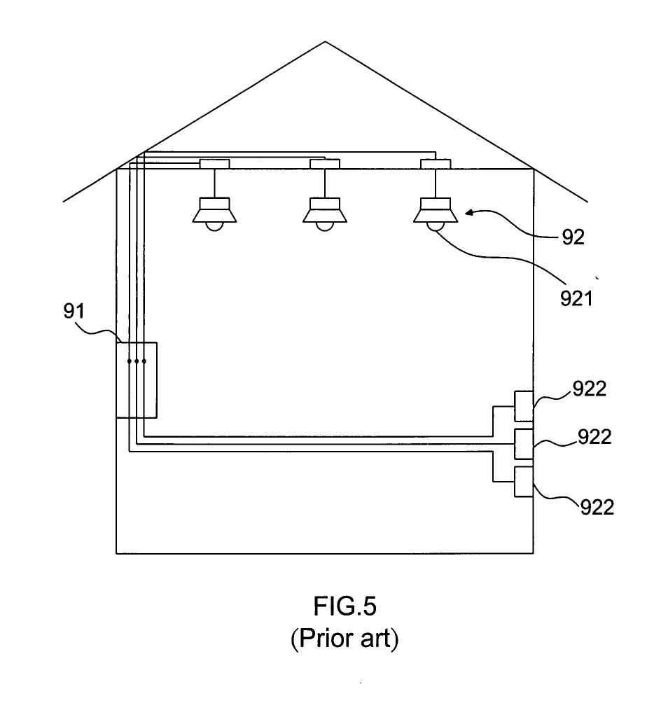

A general lamp system (as shown in FIG. 5) comprises a circuit breaker 91 and at least one lamp 92, where each lamp 92 is connecting to the circuit breaker 91; the power supply of the lamp 92 is control led by the circuit breaker 91 the lamp 92 comprises a lamp unit 921 and a switch 922; and the switching of the lamp unit 921 is control led by the switch 922.

Since the circuit breaker 91 controls the power supply of the lamp 92 and the switch 922 controls the switching of the lamp unit 921, every lamp unit 921 in a room must connect to a circuit breaker 91, and every room comprises a circuit breaker 91 to integrate the wiring for all the lamp units 921 in the room as every room in a building is usually assumed as a power supply area for an outside electric power supply. Because the circuit breaker 91 can only control a power supply within a cirtain area (a room), more circuit breakers 91 are required if a building has more rooms and so the wiring and disposition of the power lines and the circuit breakers 91 are complex. Hence, the prior art does not fulfill users' requests on actual use.

### SUMMARY OF THE INVENTION

The main purpose of the present invention is to control the switching of a lamp device by using a first and a second power frequency carrier unit coordinated with a switching device and a control member.

To achieve the above purpose, the present invention is a lamp system having power frequency carrier, comprising a switching device and at least a lamp device, where the switching device comprises a switching unit and a first power frequency carrier unit; the first power frequency carrier unit comprises a first connecting member to connect to an indoor electricity; the lamp device comprises a second power frequency carrier unit, a lamp unit and a switch; and the second power frequency carrier unit comprises a power connecting member to connect to an indoor electricity system to communicate signals with the switching device. Accordingly, a novel lamp system having power frequency carrier is obtained.

### BRIEF DESCRIPTIONS OF THE DRAWINGS

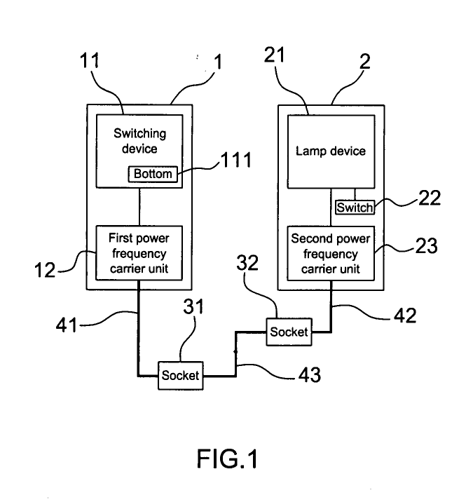

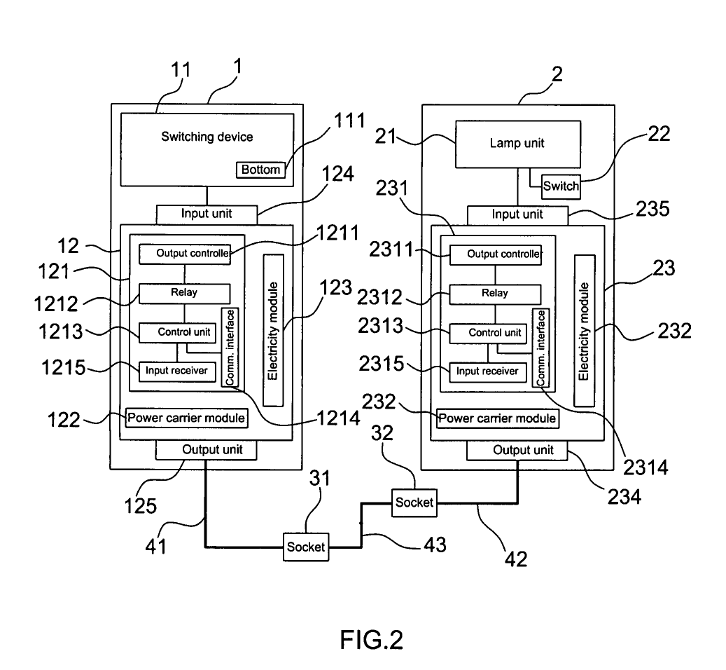

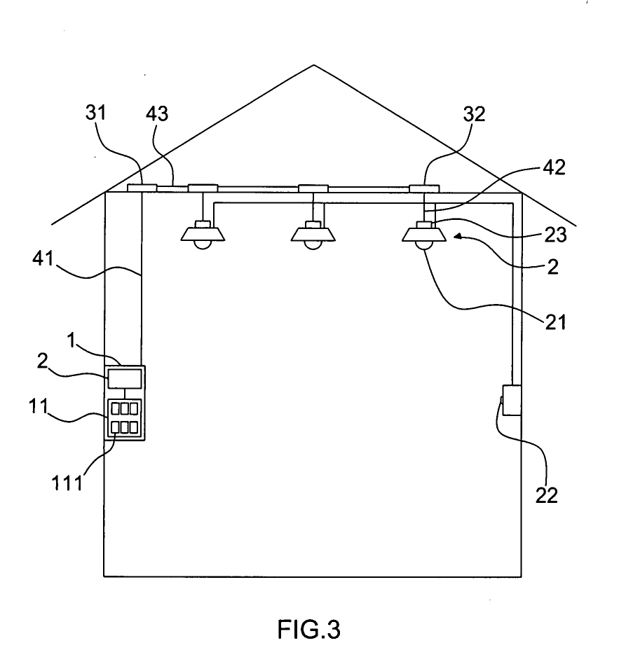

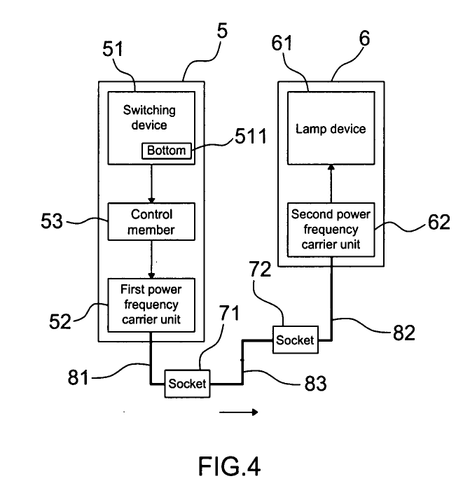

The present invention will be better understood from the following detailed descriptions of the preferred embodiments according to the present invention, taken in conjunction with the accompanying drawings, in which FIG. 1 is a fundamental view according to a first preferred embodiment of the present invention; FIG. 2 is a block view according to the first preferred embodiment of the present invention; FIG. 3 is a view showing a state of use according to the first preferred embodiment of the present invention; FIG. 4 is a view showing a state of use according to a second preferred embodiment of the present invention; and FIG. 5 is a view of a lamp system of a prior art.

### DESCRIPTION OF THE PREFERRED EMBODIMENTS

The following descriptions of the preferred embodiments are provided to understand the features and the structures of the present invention.

Please refer to FIG. 1, which is a fundamental view according to a first preferred embodiment of the present invention. As shown in the figure, the present invention is a lamp system having power frequency carrier, comprising a switching device 1 and at least one lamp device 2, where the lamp device 2 is switched on or off automatically.

The switching device 1 comprises a switching unit 11 and a first power frequency carrier unit 12; the first power frequency carrier unit 12 is connected to the switching unit 11; the switching unit 11 comprises at least one bottom 111 and each bottom 111 is corresponding to a lamp device 2; signals from the switching unit 11 are transmitted to a first socket 31 by the first power frequency carrier unit 12 through the first connecting member 41; and, signals from the first socket 31 are further transmitted along an indoor power line 43 of an indoor electricity system.

The lamp device 2 comprises a lamp unit 21, a switch 22 and a second power frequency carrier unit 23; the second power frequency carrier unit 23 is connected with the lamp unit 21; the lamp unit 21 is connected with the switch 22; the second power frequency carrier unit 23 is connected to an indoor electricity to receive signals transmitted from the switching device 1; and, the second power frequency carrier unit 23 receives the signals from a second socket 32 through a second connecting member 42. Thus, a novel lamp system having power frequency carrier is obtained.

Please further refer to FIG. 2, which is a block view according to the first preferred embodiment of the present invention. As shown in the figure, the first power frequency carrier unit 12 of the switching device 1 comprises a first single-chip control module 121, a first power carrier module 122, a first electricity module 123, a first input unit 124 and a first output unit 125, where the first power carrier module 122 comprises a baud rate of 1200 BPS (bits per second); the first electricity module 123 provides an electric power supply for the first single-chip control module 121 and the first power carrier module 122; and the first single-chip control module 121 comprises a first output controller 1211, a first relay 1212, a first control unit 11213, a first communication interface 1214 and a first input receiver 1215.

In the same way, the second power frequency carrier unit 23 of the lamp device 2 comprises a second single-chip control module 231, a second power carrier module 232, a second electricity module 233, a second input unit 234 and a second output unit 235, where the second power carrier module 232 comprises a baud rate of 2300 BPS (bits per second); the second electricity module 233 provides an electric power supply for the second single-chip control module 231 and the second power carrier module 232; and the second single-chip control module 231 comprises a second output controller 2311, a second relay 2323, a second control unit 2313, a second communication interface 2314 and a second input receiver 2315.

Therein, each of the first and the second control units 1213,2313 in the first and the second power frequency carrier unit 12,23 is respectively a 8051 single-chip as a processing unit with a good inner structure, whose working frequency is up to 16 MHz with a 4 k size of electrically programmable and erasable ROM (Read Only Memory) together with eight in put pins and eight output pins. Each of the first and the second relay 1212,2312 is located at the output pins of the 8051 single-chip to quarantine the circuit for securing and ensuring the operation of the 8051 single-chip. Each 8051 single-chip contains a full-duplex communication interface inside, which are the first and the second communication interfaces 1214,2314. Each of the first and the second communication interface 1214,2314 is an RS232 interface to simultaneously transfer and receive data to and from outside. The operational signals in the 8051 single-chip are on a TTL (transistor-transistor-logic) level (0 voltage set as logic 0 and +5 voltage set as logic 1) and each of the first and the second communication interface 1214,2314 is a serial communication interface to transfer and receive data in a form of bit series.

Please refer to FIG. 3, which is a view showing a state of use according to the first preferred embodiment of the present invention. As shown in the figure, when using the present invention, a few lamp devices 2 are located in a room or an area of a building with a switching device 1 deposed on a required place, where the switching device 1 is plugged in a first socket 31 with a first connecting member 41 and the lamp devices 2 are plugged in second sockets 32 with second connecting members 42; and each lamp device 2 is corresponding to a bottom 111 on a switching unit 11 of the switching device 1. When a user wants to power on or off a lamp unit 21 the user pushes the corresponding bottom 111. A signal entered from the bottom 111 is transmitted through a first input unit 124 into a first power frequency carrier unit 12, where the signal is encoded and integrated with a power signal by a first single-chip control module 121, a first power carrier module 122 and a first electricity module 123. After a transmission mode and a transmission speed are detected and setup by the single-chip control module 121, the signal is then transmitted out from a first output unit 125 of the first power frequency carrier unit 12 to a socket 31 through a first connecting member 41. The signal is further transmitted along an indoor power line 43 and is received by a second power frequency carrier unit 23 with a second socket 32 through a second connecting member 42. After the signal is received from a second input unit 234, the signal is separated and decoded into the orginal signal and the power signal by a second single-chip control module 231, a second power carrier module 232 and a second electricity module 233 to decide whether to power on or off the lamp unit 21. If the user wants to power on the lamp unit 21, the power signal is sent to the lamp unit 21 so that the user can switch on or off the lamp unit 21 by a switch 22. If the user wants to power off the lamp unit 21, the power supply is cut from the lamp unit 21 to disable its function and the lamp unit 21 is not switchable by the switch 22.

Please refer to FIG. 4, which is a view showing a state of use according to a second preferred embodiment of the present invention. As shown in the figure, a control member 53 is further located in a switching device 5 and is connected between a switching unit 51 and a first power frequency carrier unit 52; and, the control member 53 comprises at least a counter or a timer to control the switching of at least one lamp device 6.

When the control member 53 comprises a counter, the counter can be setup to switch on and off a lamp device 6 several times before powering off the lamp device 6. Or, when the control member 53 comprises a timer, the timer can be setup to switch on a lamp device 6 at a certain time and to switch off the lamp device 6 at another time. By doing so, even the user is not in the house, the lamp device 6 is still switched on and off as if done by the user himself, where an illegal invasion into the house may be prevented.

Therein, when a bottom 51 in the switching device 51 is pressed, a control signal from the control member 53 is transmitted to the first power frequency carrier unit 52 to be integrated and encoded with a power signal to obtain an integrated signal. After a transmission mode and a transmission speed are detected, the integrated signal is transmitted along a first connecting member 81 to a first socket 71. Then the signal is further transmitted to a second socket 72 a long an indoor power line 83 to be received by a second power frequency carrier unit 62 of the lamp device 6 with a second connecting member 82. In the end, the signal is decoded by the second power frequency carrier unit 62 to control the switching of a lamp device 61 of the lamp device 6.

To sum up, the present invention is a lamp system having power frequency carrier, where a switching of a lamp device is automatically controlled by using a first and a second power frequency carrier unit coordinated with a switching device and a control member.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A lamp system having power frequency carrier, comprising:
(a) a switching device comprising a switching unit and a first power frequency carrier unit, said first power frequency carrier unit connecting to said switching unit, said first power frequency carrier unit comprising a first connecting member to connect to an indoor electricity system; and
(b) at least one lamp device comprising a lamp unit, a switch and a second power frequency carrier unit, said lamp unit connecting to said second power frequency carrier unit, said switch connecting to said lamp unit, said second power frequency carrier unit comprising a second connecting member to connect to said indoor electricity system for receiving signals from said switching device.

2. The lamp system according to claim 1, wherein said switching unit comprises at least one bottom corresponding to said at least one lamp device to switch said lamp device.

3. The lamp system according to claim 1, wherein each of said first and said second power frequency carrier units comprises a single-chip control module, a power carrier module, an electricity module, an output unit and an input unit.

4. The lamp system according to claim 3, wherein said single-chip control module comprises an input receiver, an output controller, a control unit, a communication interface and a relay.

5. The lamp system according to claim 3, wherein said power carrier module comprises a transmission rate of b 1200 BPS (bit per second).

6. The lamp system according to claim 4, wherein said control unit is a 8051 single-chip.

7. The lamp system according to claim 4, wherein said control unit comprises a working frequency up to 16 MHz (megahertz ).

8. The lamp system according to claim 4, wherein said communication interface is an RS232 interface.

9. The lamp system according to claim 1, wherein a control member is further located in said switching device and said control member is connected between said switching unit and said first power frequency carrier unit to control said lamp device.

10. The lamp system according to claim 1, wherein said control member is a counter.

11. The lamp system according to claim 1, wherein said control member is a timer.
